(19) United States
(12) Patent Application Publication
(10) Pub. No.: US 2014/0356683 A1
(43) Pub. Date: Dec. 4, 2014

(54) BATTERY MODULE

(71) Applicants: ROBERT BOSCH GMBH, Stuttgart (DE); SAMSUNG SDI CO., LTD., Yongin-si (KR)

(72) Inventors: Young-Deok KIM, Yongin-si (KR); Jeong-Joo LEE, Yongin-si (KR)

(73) Assignees: ROBERT BOSCH GMBH, Stuttgart (DE); SAMSUNG SDI CO., LTD., Yongin-si (KR)

(21) Appl. No.: 14/193,154

(22) Filed: Feb. 28, 2014

(30) Foreign Application Priority Data
May 30, 2013 (KR) 10-2013-0061606

(51) Int. Cl. H01M 2/10

(52) U.S. Cl. CPC H01M 2/1077
USPC 429/120; 429/156

(57) ABSTRACT

A battery module including a plurality of battery cells aligned in one direction; and first and second fixing members on outer surfaces of the plurality of battery cells, the first and second fixing members respectively having first and second fastening portions, wherein the first and second fastening portions are coupled together by being fused to each other.

### CROSS-REFERENCE TO RELATED APPLICATION

Korean Patent Application No. 10-2013-0061606, filed on May 30, 2013, in the Korean Intellectual Property Office, and entitled: “Battery Module,” is incorporated by reference herein in its entirety.

### BACKGROUND

1. Field

Embodiments relate to a battery module.

2. Description of the Related Art

A high-power battery module may use a non-aqueous electrolyte with high energy density. The high-power battery module may be configured as a large-capacity battery module manufactured by connecting a plurality of battery cells in series so as to be used for driving devices, e.g., motors of electric vehicles or the like, which require high power.

### SUMMARY

Embodiments are directed to a battery module.

The embodiments may be realized by providing a battery module including a plurality of battery cells aligned in one direction; and first and second fixing members on outer surfaces of the plurality of battery cells, the first and second fixing members respectively having first and second fastening portions, wherein the first and second fastening portions are coupled together by being fused to each other.

The first fastening portion may include a protruding portion, and the second fastening portion may include an accommodating portion into which the protruding portion is inserted.

The accommodating portion may have a stepped interior.

The protruding portion may be inserted into the accommodating portion and fused to the accommodating portion.

The first and second fastening portions may be fused to each other through laser welding.

At least one of the first and second fixing members may include an additive, the additive being capable of transmitting laser light therethrough.

The additive may include AS 66 GF 25H.

The first and second fixing members may include a plastic or polymeric material.

The first fixing member may cover at least three surfaces of the plurality of battery cells.

The first fixing member may be integrally formed as a one-piece unit through injection molding.

The first fixing member may cover opposing side surfaces of the plurality of battery cells and a first end surface of the plurality of battery cells, the first end surface of the plurality of battery cells being connected to both side surfaces of the plurality of battery cells, and the second fixing member may cover a second end surface of the plurality of battery cells, the second end surface of the plurality of battery cells being a surface opposite to the first end surface of the plurality of battery cells.

The first fixing member may further cover a top surface of the plurality of battery cells.

The first fixing member that covers the top surface of the plurality of battery cells may include first and second openings, positive and negative electrode terminals of each battery cell respectively passing through the first and second openings.

The first fixing member that covers the top surface of the plurality of battery cells may include a third opening, the third opening exposing a vent of each battery cell to an outside of the battery module.

The battery module may be water cooled.

### BRIEF DESCRIPTION OF THE DRAWINGS

Features will be apparent to those of skill in the art by describing in detail exemplary embodiments with reference to the attached drawings in which:

FIG. 1 illustrates a perspective view of a battery module according to an embodiment.

FIG. 2 illustrates an exploded perspective view of the battery module shown in FIG. 1.

FIG. 3 illustrates an enlarged sectional view showing a coupling structure between first and second fastening portions in the battery module shown in FIG. 1.

FIG. 4 illustrates an enlarged sectional view showing a coupling structure between the first and second fastening portions before laser welding is performed in the battery module shown in FIG. 1.

FIG. 5 illustrates a perspective view of a battery module according to another embodiment.

FIG. 6 illustrates an exploded perspective view of the battery module shown in FIG. 5.

FIG. 7 illustrates an enlarged sectional view showing a coupling structure between first and second fastening portions in the battery module shown in FIG. 5.

FIG. 8 illustrates an enlarged sectional view showing a coupling structure between the first and second fastening portions before laser welding is performed in the battery module shown in FIG. 5.

FIG. 9 illustrates a perspective view of a battery module according to still another embodiment.

FIG. 10 illustrates an exploded perspective view of the battery module shown in FIG. 9.

FIG. 11 illustrates an enlarged sectional view showing a coupling structure between first and second fastening portions in the battery module shown in FIG. 9.

FIG. 12 illustrates an enlarged sectional view showing a coupling structure between the first and second fastening portions before laser welding is performed in the battery module shown in FIG. 9.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

Terms or words used in this specification and claims should not be restrictively interpreted as ordinary meanings or dictionary-based meanings, but should be interpreted as meanings and concepts conforming to the embodiments on the basis of the principle that an inventor can properly define the concept of a term to describe and explain the embodiments in the best ways.

Also, when an element is referred to as being “connected to” another element, it can be directly connected to the another element or be indirectly connected to the another element with one or more intervening elements interposed therebetween.

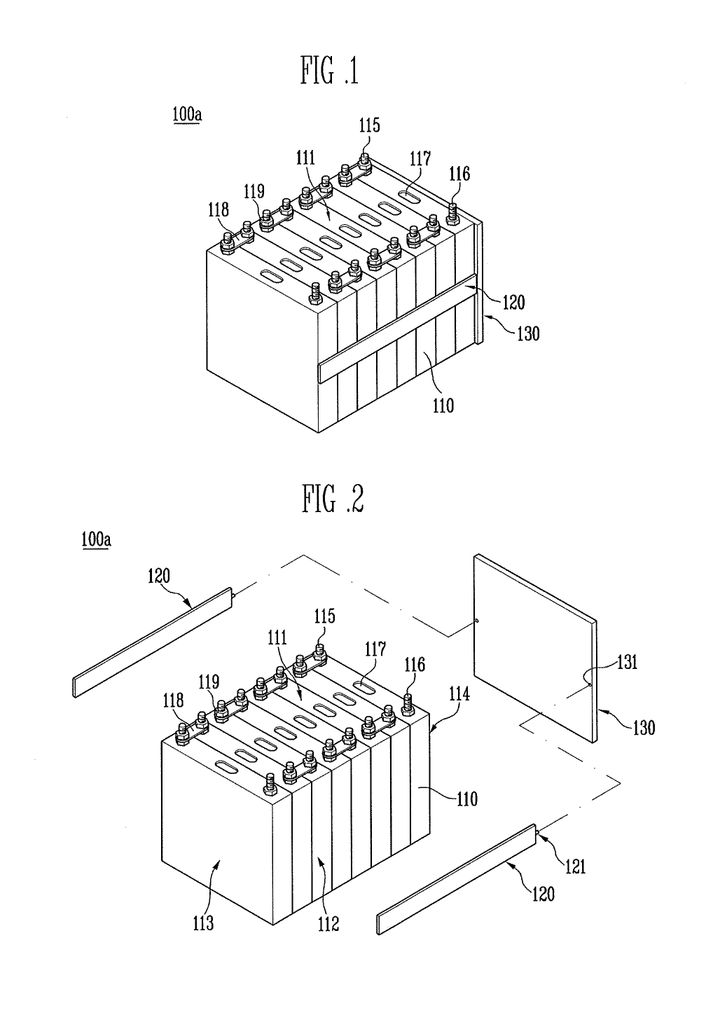

FIG. 1 illustrates a perspective view of a battery module 100a according to an embodiment. FIG. 2 illustrates an exploded perspective view of the battery module 100a shown in FIG. 1. Hereinafter, the battery module 100a according to this embodiment will be described with reference to FIGS. 1 and 2.

As shown in FIGS. 1 and 2, the battery module 100a according to the present embodiment may include a plurality of battery cells 110 aligned in one direction, a first fixing member 120 on an outer surface of the plurality of battery cells 110, and a second fixing member 130 coupled with the first fixing member 120 and on another outer surface of the plurality of battery cells 110.

The battery cell 110 may be a member that generates energy. The battery cell 110 may be formed in plural numbers. The plurality of battery cells 110 may be aligned in the one direction.

In an implementation, each battery cell 110 may include a battery case having one opened side, and an electrode assembly and an electrolyte accommodated in the battery case. The electrode assembly and the electrolyte may generate energy through an electrochemical reaction therebetween. The battery case may be sealed by a top surface 111 of the battery cell 110 including, e.g., a cap assembly. Positive and negative electrode terminals 115 and 116 (having different polarities) may be provided to protrude from the top surface 111 of the battery cell 110. A vent 117 may be further provided as a safety device on the top surface 111 of the battery cell 110. The vent 117 may act as a passage through which gas generated inside the battery cell 110 is exhausted to an outside of the battery cell 110. Among the plurality of battery cells 110, neighboring battery cells 110 may be electrically connected through a bus-bar 118. The bus-bar 118 may be fixed to the positive and negative electrode terminals 115 and 116 by a fixing mechanism 119, e.g., a nut.

The first fixing member 120 may be a member that is on an outer surface of the plurality of battery cells 110 so as to fix an alignment state of the plurality of battery cells 110.

In an implementation, as shown in FIGS. 1 and 2, the first fixing member 120 may be on one or both, e.g., opposing, side surfaces 112 of the plurality of battery cells 110 (among the outer surfaces of the plurality of battery cells 110) so as to support the battery cell 110. The first fixing member 120 may surround or cover a portion of the side surface 112 of the plurality of battery cells 110 as shown in FIG. 1, or may surround or cover the entire side surface 112 of the plurality of battery cells 110.

The first fixing member 120 may include a plastic or polymeric material. In other battery modules, an SUS stainless steel plate may be used as a member that fixes battery cells. However, it may be difficult to control a shape of the SUS plate. In the battery module 100a according to the present embodiment, the plastic or polymeric material may be used to form the fixing member 120. Thus, it may be easy to control the shape of the fixing member 120, as compared with the SUS plate. Accordingly, the productivity of the battery module 100a may be improved. In a case where the fixing member 120 includes the plastic or polymeric material, a weight of the fixing member 120 may be decreased, as compared with a SUS plate. Accordingly, it is possible to reduce manufacturing cost. The plastic or polymeric material may be a nonconductor or insulator. Thus, the first fixing member 120 may serve in itself as an insulating material, and accordingly, a separate insulating material may not be necessary.

The second fixing member 130 may be a member that is coupled with the first fixing member. The second fixing member 130 may be on an outer or end surface of the plurality of battery cells 110.

In an implementation, the second fixing member 130 may be on a wide surface of an outermost battery cell 110 so as to be coupled with the first fixing member 120. For example, the second fixing member 130 may be on an end of the battery module 100a. For example, the wide surfaces of the outermost battery cells 110, i.e., the surfaces connecting the side surfaces 112 of the plurality of battery cells 110, may be referred to as first and second surfaces 113 and 114 of the plurality of battery cells 110. Thus, the second fixing member 130 may be positioned to surround or cover the second surface 114, i.e., one of the ends of the battery module 100a. In a case where the first fixing member 120 is positioned on the side surfaces 112 of the plurality of battery cells 110, the first and second fixing members 120 and 130 may be and may meet perpendicular to each other. Accordingly, the second fixing member 130 may firmly fix, together with the first fixing member 120, the plurality of battery cells 110 aligned in the one direction. Like the first fixing member 120, the second fixing member 130 may include plastic or a polymeric material. Accordingly, it is possible to improve the productivity of the battery module 100a, to decrease the weight of the battery module 100a, and to reduce the manufacturing cost of the battery module 100a.

In an implementation, the first and second fixing members 120 and 130 may be coupled with each other by fusing of first and second fastening portions 121 and 131, respectively. This will be described in detail as follows.

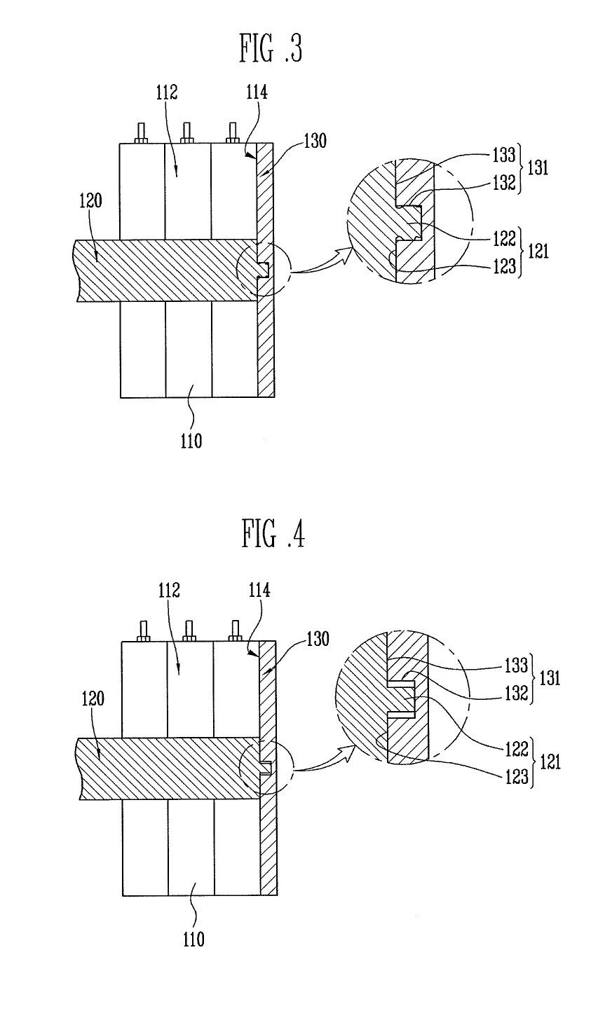

FIG. 3 illustrates an enlarged sectional view showing a coupling structure between the first and second fastening portions 121 and 131 in the battery module shown in FIG. 1. FIG. 4 illustrates an enlarged sectional view showing a coupling structure between the first and second fastening portions 121 and 131 before laser welding is performed in the battery module 100a shown in FIG. 1. Hereinafter, the coupling structure of the first and second fixing members 120 and 130 according to the present embodiment will be described with reference to FIGS. 3 and 4.

As shown in FIG. 3, the first fixing member 120 may include a first fastening portion 121, and the second fixing member 130 may include a second fastening portion 131. The first fastening portion 121 may include a protruding portion 122 and a peripheral portion 123 of the protruding portion 122. The second fastening portion 131 may include an accommodating portion 132 and a peripheral portion 133 of the accommodating portion 132. The first fastening portion 121 may be integrally formed (e.g., as a one-piece unit) with the first fixing member 120, and the second fastening portion 131 may be integrally formed (e.g., as a one-piece unit) with the second fixing member 130. In an implementation, the protruding portion 122 may be inserted into the accommodating portion 132 so that the protruding portion 122 and the accommodating portion 132 may then be fused to each other. The peripheral portion 123 of the protruding portion 122 may also be fused to the peripheral portion 133 of the accommodating portion 132. As the first and second fastening portions 121 and 131 are fused to each other, the first and second fixing members 120 and 130 may thus be coupled with each other.

In an implementation, fusing of the first and second fastening portions 121 and 131 may be performed through, e.g., laser welding. For example, a place where the first and second fastening portions 121 and 131 meet each other may be welded using a laser. Accordingly, the fusing of the first and second fastening portions 121 and 131 may be performed. In an implementation, a portion of the protruding portion 122, as shown in FIG. 3, may be melted through the laser welding, so as to be completely fused with the accommodating portion 132. Accordingly, the first and second fixing members 120 and 130 may be strongly fixed to each other.

For example, in a case where the first fixing member 120 (including the first fastening portion 121) and the second fixing member 130 (including the second fastening portion 131) include plastic or a polymeric material, the first and second fixing members 120 and 130 may be suitable for laser welding. On the other hand, a SUS plate may be welded, but it may be difficult to perform such a welding process. Therefore, it may take a long time to perform the SUS welding process. Accordingly, the battery cell 110 may be damaged due to heat during the welding process. However, in the present embodiment, the first and second fixing members 120 and 130 may include the plastic or polymeric material. Thus, the welding process may be easily performed at a relatively low temperature. Accordingly, it is possible to reduce the probability that the battery cell 110 may be damaged due to heat.

When the laser welding is performed, one of the first or second fixing member 120 or 130 may include an additive through which laser light is transmitted. Accordingly, energy of the laser may be well transferred to the place where the first and second fastening portions 121 and 131 meet each other. For example, AS 66 GF 25H may be used as the additive. Accordingly, energy from the laser may be smoothly transferred to the place where the first and second fastening portions 121 and 131 meet each other by being transmitted through the first and/or second fixing member 120 or 130.

In an implementation, the first and second fastening portions 121 and 131 may be fused to each other by the laser welding. Accordingly, it may not be necessary for the protruding portion 122 and the accommodating portion 132 to be the same size as or be perfectly fitted in an early or preliminary stage of coupling (e.g., before the laser welding is performed). For example, before the laser welding is performed, there may be no problems or concerns, even if a diameter or width of the protruding portion 122 is smaller than a size of the accommodating portion 132. A portion of the protruding portion 122 may be melted and then fused to the accommodating portion 132 during the laser welding. Accordingly, any space between the protruding portion 122 and the accommodating portion 132 (at the preliminary stage) may be filled with the melted protruding portion 122 to an extent as shown in FIG. 3. Thus, ensuring that sizes match or a perfect fit of the protruding portion 122 and the accommodating portion 132 may not be necessary. Therefore, it may not be necessary to seriously consider a manufacturing tolerance. Accordingly, manufacturing of the first and second fastening portions 121 and 131 may be facilitated, thereby further improving the productivity of the battery module 100a.

In a case where the first and second fixing members 120 and 130 are coupled with each other in such a manner that the first and second fastening portions 121 and 131 are fused as described above, an external appearance of the battery module 100a (which may be manufactured as a final product through a simple manufacturing process) may be more neat and tidy, as compared with other types of battery modules. For example, other types of fixing members in battery cells may be connected to each other by a bolt. In this case, a bolt opening may be separately made, and the bolt may protrude to the outside of the member. Therefore, the external appearance of the existing battery module may not be considered neat and tidy. However, in the battery module 100a according to the embodiments, the manufacturing process may be simplified using the fusing, and there may be no structure separately protruded from the fixing member. Accordingly, the external appearance of the battery module 100a may be neat and tidy.

Meanwhile, although FIGS. 1 to 4 illustrate that the first fastening portion 121 includes one protruding portion 122 and the second fastening portion 131 includes one accommodating portion 132, the embodiments are not limited thereto. For example, a plurality of protruding portions 122 and a plurality of corresponding accommodating portions 132 may be used. In addition, although it has been described in this embodiment that the first fixing member 120 may be disposed on the side surfaces 112 of the plurality of battery cells 110 and the second fixing member 130 is disposed on the end or second surface 114, positions of the first and second fixing members 120 and 130 are not limited thereto.

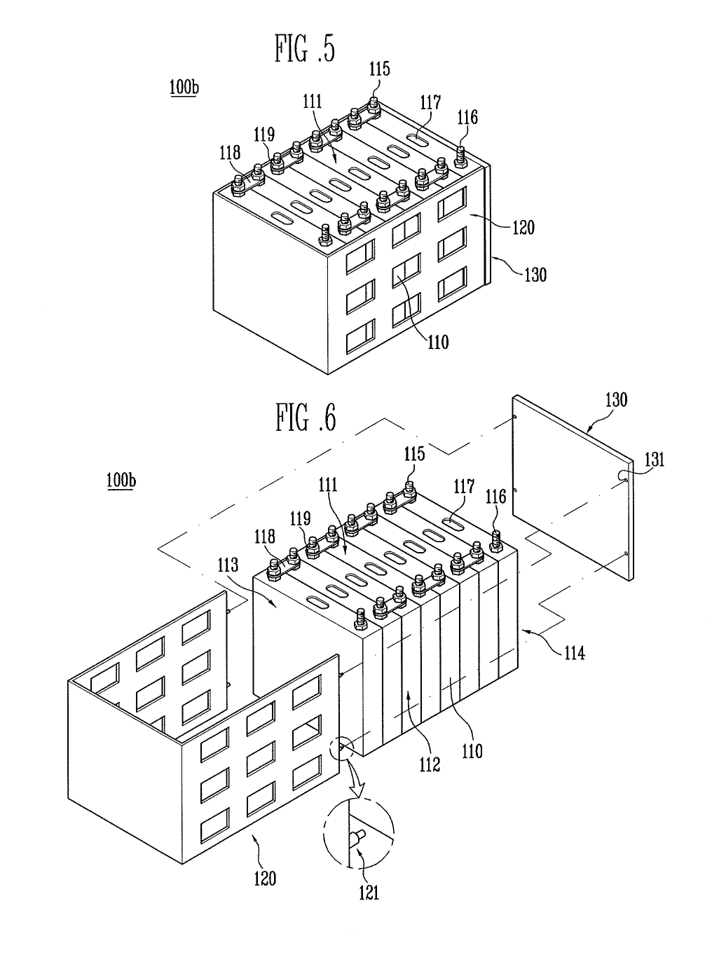

FIG. 5 illustrates a perspective view of a battery module 100b according to another embodiment. FIG. 6 illustrates an exploded perspective view of the battery module 100b shown in FIG. 5. Hereinafter, the battery module 100b according to this embodiment will be described with reference to FIGS. 5 and 6. In the present embodiment, components identical or corresponding to those of the aforementioned embodiment are designated by like reference numerals, and repeated detailed descriptions may be omitted to avoid redundancy.

As shown in FIGS. 5 and 6, the battery module 100b according to the present embodiment may include a plurality of battery cells 110 aligned in one direction, a first fixing member 120 configured to surround or cover three surfaces of the plurality of battery cells 110, and a second fixing member 130 on a second end surface 114 among outer surfaces of the plurality of battery cells 110.

In an implementation, the first fixing member 120 may surround or cover three surfaces of the plurality of battery cells 110. For example, the first fixing member 120 may surround or cover both side surfaces 112 (e.g., opposite and parallel to each other) and a first end surface 113 of the plurality of battery cells 110. For example, the first fixing member 120 may surround or cover three surfaces among the four lateral surfaces of the plurality of battery cells 110. In this case, the one surface not surrounded or covered by the first fixing member 120 may correspond to the second end surface 114 (e.g., opposite and parallel to the first end surface 113). The second end surface 114 may be surrounded or covered by the second fixing member 130.

The first fixing member 120 may be integrally formed (e.g., as a one-piece unit) through injection molding. For example, when the first fixing member 120 is made of plastic or a polymeric material, it may be inconvenient for the first fixing member 120 to be formed as three separate plates that are then connected to one another, like the case when an SUS plate is used. Thus, in the present embodiment, the first fixing member 120 may be formed through plastic injection molding. In this case, the battery module 100b may be easily manufactured, and the productivity of the battery module 100b may be further improved.

In an implementation, a water cooling method may be used as a cooling method of the battery module 100b, e.g., the battery module 100b may be water cooled. Thus, the first fixing member 120 may not surround or cover a bottom surface of the plurality of battery cells 110 (in order to allow the cooling water or fluid to reach the battery cells 110). However, the embodiments are not limited thereto, and in an implementation the first fixing member 120 may surround or cover even the bottom surface of the plurality of battery cells 110.

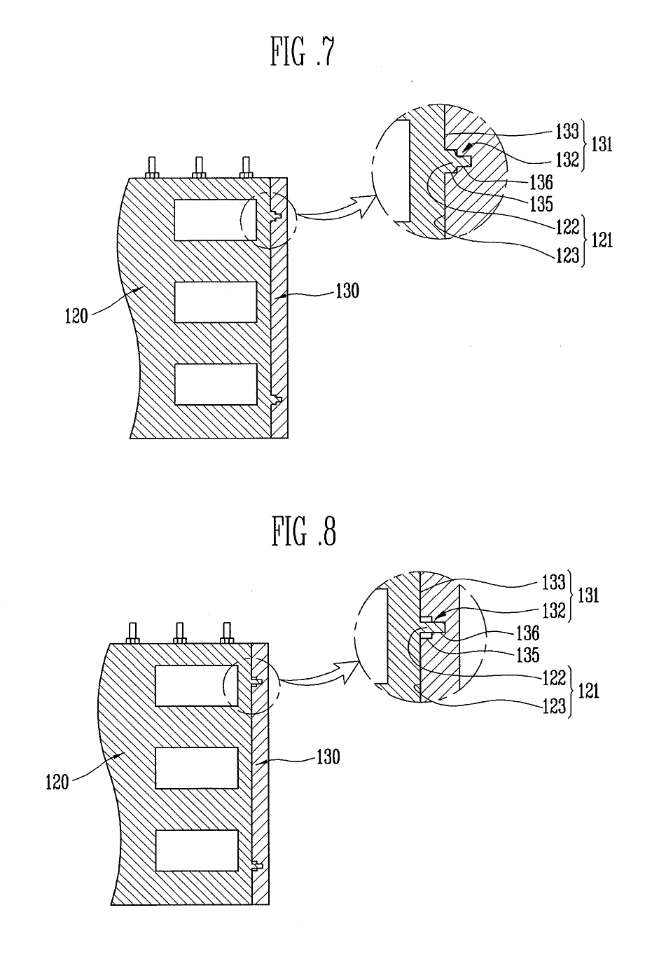

FIG. 7 illustrates an enlarged sectional view showing a coupling structure between first and second fastening portions 121 and 131 in the battery module 100b shown in FIG. 5. FIG. 8 illustrates an enlarged sectional view showing a coupling structure between the first and second fastening portions 121 and 131 before laser welding is performed in the battery module 100b shown in FIG. 5. Hereinafter, the connection or coupling structure of the first and second fixing members 120 and 130 according to this embodiment will be described with reference to FIGS. 7 and 8.

As shown in FIG. 7, the first fixing member 120 may have the first fastening portion 121 (including a protruding portion 122 and a peripheral portion 123 of the protruding portion 122). The second fixing member 130 may have the second fastening portion 131 (including an accommodating portion 132 and a peripheral portion 133 of the accommodating portion 132). The first and second fastening portions 121 and 131 may be fused to each other through, e.g., laser welding. In the present embodiment, the accommodating portion 132 may have a stepped shape. For example, the protruding portion 122 may be fused to the accommodating portion 132 through the laser welding. Therefore, the protruding portion 122 may be transformed into a shape corresponding to that of the accommodating portion 132. For example, after welding, the protruding portion 122 may also have a stepped shape.

In this case, an initial shape of the protruding portion 122 may not be the stepped shape as shown in FIG. 7. For example, the accommodating portion 132 may include a first accommodating portion 135 (having a relatively larger diameter or size) and a second accommodating portion 136 (having a relatively smaller diameter or size), based on a step difference. The protruding portion 122 may have a diameter or size corresponding to that of the second accommodating portion 136, without any step difference in an early or preliminary stage (e.g., before the laser welding is performed). Therefore, prior to performing the laser welding, end portions of the protruding portion 122 may be fixed to or coupled with the second accommodating portion 136, using a mechanical method (e.g., a snap-fit method), by passing through the first accommodating portion 135 (see FIG. 8). Subsequently, other portions of the protruding portion 122 at the first accommodating portion 135 may be melted by the laser welding and then fused to the first accommodating portion 135 (see FIG. 7). The end portions of protruding portion 122 (fixed using the snap-fit method) may also be melted and then fused to the second accommodating portion 136. For example, in the present embodiment, the first and second fastening portions 121 and 131 may have a double coupling structure of the snap-fit coupling structure between the end portions of the protruding portion 122 and the second accommodating portion 136 and the fusion coupling structure between the first and second fastening portions 121 and 131. Accordingly, coupling strength or reliability between the first and second fixing members 120 and 130 may be be further increased, as compared with other types of battery modules.

In order to balance the coupling between the first and second fixing members 120 and 130, the second fastening portion 131 may be placed at, e.g., four, portions of the second fixing member 130, as shown in FIG. 6, and the first fastening portion 121 may be placed on the first fixing member 120 at positions corresponding to that of the second fastening portion 131. However, the positions and numbers of the first and second fastening portions 121 and 131 are not limited thereto.

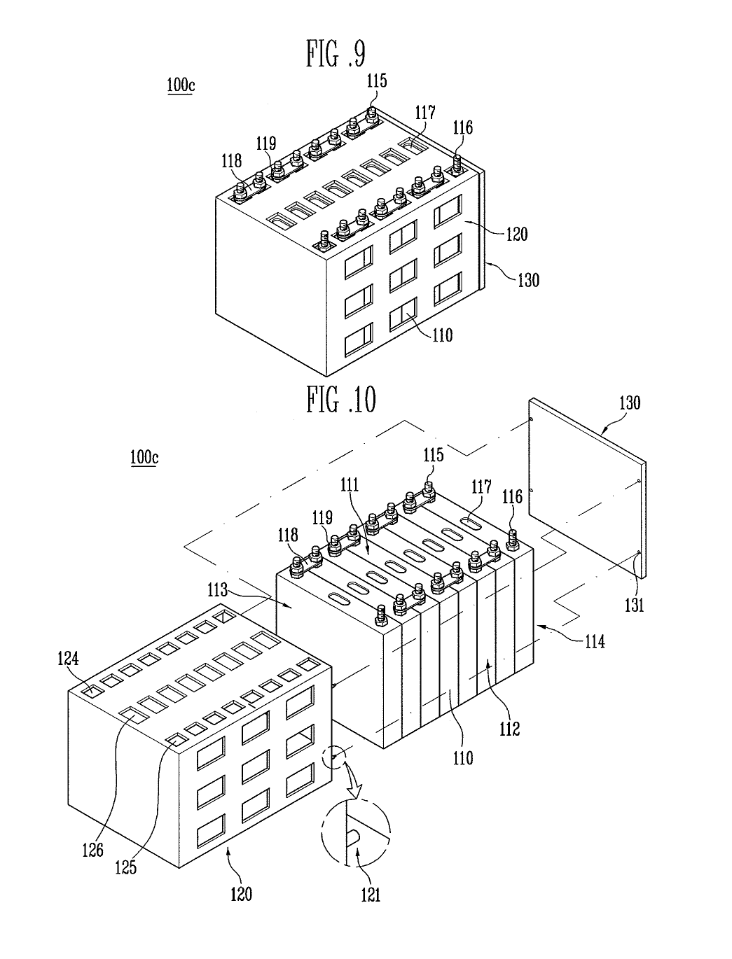

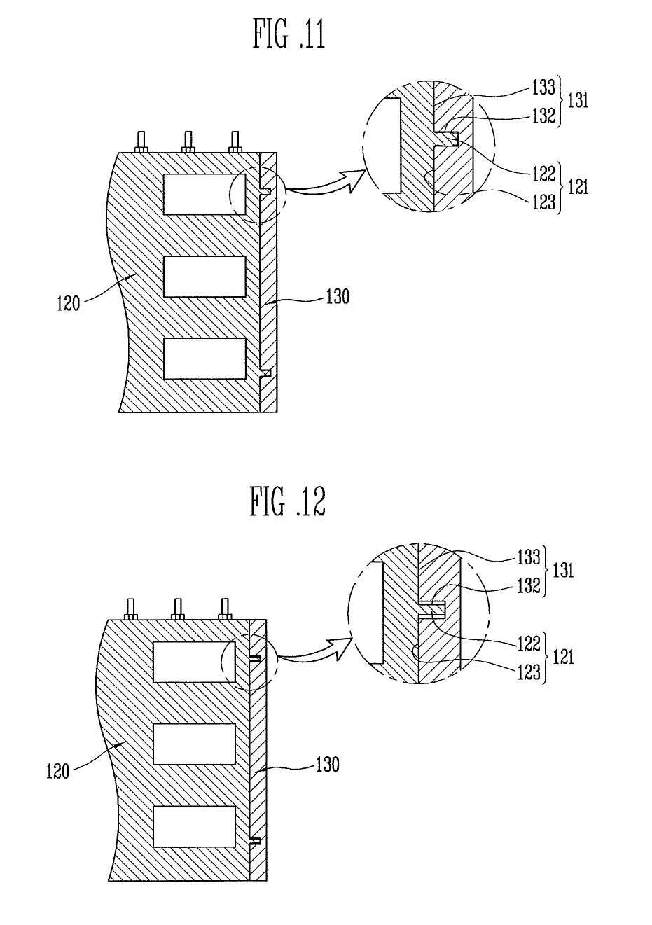

FIG. 9 illustrates a perspective view of a battery module 100c according to still another embodiment. FIG. 10 illustrates an exploded perspective view of the battery module 100c shown in FIG. 9. FIG. 11 illustrates an enlarged sectional view showing a coupling structure between first and second fastening portions 121 and 131 in the battery module 100c shown in FIG. 9. FIG. 12 illustrates an enlarged sectional view showing a coupling structure between the first and second fastening portions 121 and 131 before laser welding is performed in the battery module 100c shown in FIG. 9. Hereinafter, the battery module 100c according to the present embodiment will be described with reference to FIGS. 9 to 12. In this embodiment, components identical or corresponding to those of the aforementioned embodiment are designated by like reference numerals, and repeated detailed descriptions may be omitted to avoid redundancy.

As shown in FIGS. 9 and 10, the battery module 100c according to the present embodiment may include a plurality of battery cells 110, a first fixing member 120 (surrounding or covering four surfaces of the plurality of battery cells 110), and a second fixing member 130 (connected to or coupled with the first fixing member 120 so as to be on or covering a second end surface 114 of the plurality of battery cells 110).

In an implementation, the first fixing member 120 may surround or cover a top surface 111 of the plurality of battery cells 110, in addition to other surfaces. For example, the first fixing member 120 may surround or cover both side surfaces 112, a first end surface 113, and the top surface 111. The second fixing member 130 may surround or cover the second end surface 114, e.g., another surface among the four side or lateral surfaces of the plurality of battery cells 110.

In this case, the positive and negative electrode terminals 115 and 116 may protrude from each battery cell 110. Therefore, first and second openings 124 and 125 may be formed in a portion of the first fixing member 120 that is positioned on the top surface 111 of the plurality of battery cells 110 so that the positive and negative electrode terminals 115 and 116 may protrude and be exposed to the outside of the battery module 100c. Thus, the positive electrode terminal 115 may be exposed to the outside of the battery module 100c by passing through the first fixing member 120 at the first opening 124, and the negative electrode terminal 116 may be exposed to the outside of the battery module 100c by passing through the first fixing member 120 at the second opening 125. The bus-bar 118 (connecting the exposed positive and negative electrode terminals 115 and 116 to each other) may be connected to the positive and negative electrode terminals 115 and 116 at an outside of the fixing member 120 (see FIGS. 1 and 9). The vent 117 in the top surface 111 of the battery cell 110 should be exposed to the outside of the battery module 100c so that gas may be exhausted therethrough. Thus, a third opening 126 may be further formed in the first fixing member 120. Accordingly, the vent 117 may be exposed to the outside of the battery module 100c.

As shown in FIGS. 11 and 12, a first fastening portion 121 (including a protruding portion 122) may be on to the first fixing member 120, and a second fastening portion 131 (including an accommodating portion 132) may be provided on the second fixing member 130. Their structures and functions may be the same as those described in the aforementioned embodiments.

By way of summation and review, as a number of devices employing the battery module increases, improving the productivity of the battery module may be desirable. As an external appearance of the devices is diversified, a shape of the battery module may be varied. However, safety of the battery module should be basically secured. Therefore, the structure of a battery module capable of satisfying all the requirements may be desirable.

Embodiments provide a battery module capable of improving the productivity thereof by employing a new structure.

Embodiments also provide a battery module in which battery cells can be firmly fixed so as not to be moved, thereby improving the safety of the battery module.

In the battery module according to an embodiment, the first and second fixing members are coupled to each other through fusion between the first and second fastening portions, so that it is possible to easily manufacture the battery module, to reduce manufacturing time and cost, and to improve the productivity of the battery module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells aligned in one direction; and
first and second fixing members on outer surfaces of the plurality of battery cells, the first and second fixing members respectively having first and second fastening portions,
wherein the first and second fastening portions are coupled together by being fused to each other.

2. The battery module as claimed in claim 1, wherein:
the first fastening portion includes a protruding portion, and
the second fastening portion includes an accommodating portion into which the protruding portion is inserted.

3. The battery module as claimed in claim 2, wherein the accommodating portion has a stepped interior.

4. The battery module as claimed in claim 2, wherein the protruding portion is inserted into the accommodating portion and fused to the accommodating portion.

5. The battery module as claimed in claim 1, wherein the first and second fastening portions are fused to each other through laser welding.

6. The battery module as claimed in claim 5, wherein at least one of the first and second fixing members includes an additive, the additive being capable of transmitting laser light therethrough.

7. The battery module as claimed in claim 1, wherein the first and second fixing members include a plastic or polymeric material.

8. The battery module as claimed in claim 1, wherein the first fixing member covers at least three surfaces of the plurality of battery cells.

9. The battery module as claimed in claim 8, wherein the first fixing member is integrally formed as a one-piece unit through injection molding.

10. The battery module as claimed in claim 1, wherein:
the first fixing member covers opposing side surfaces of the plurality of battery cells and a first end surface of the plurality of battery cells, the first end surface of the plurality of battery cells being connected to both side surfaces of the plurality of battery cells, and
the second fixing member covers a second end surface of the plurality of battery cells, the second end surface of the plurality of battery cells being a surface opposite to the first end surface of the plurality of battery cells.

11. The battery module as claimed in claim 10, wherein the first fixing member further covers a top surface of the plurality of battery cells.

12. The battery module as claimed in claim 11, wherein the first fixing member that covers the top surface of the plurality of battery cells includes first and second openings, positive and negative electrode terminals of each battery cell respectively passing through the first and second openings.

13. The battery module as claimed in claim 11, wherein the first fixing member that covers the top surface of the plurality of battery cells includes a third opening, the third opening exposing a vent of each battery cell to an outside of the battery module.

14. The battery module as claimed in claim 1, wherein the battery module is water cooled.
